(19) United States
(12) Patent Application Publication
(10) Pub. No.: US 2026/0288666 A1
(43) Pub. Date: Sep. 24, 2026

(54) SELECTIVE ROLE SETTING BY A MANAGEMENT CONTROLLER

(71) Applicant: Hewlett Packard Enterprise Development LP, Spring, TX (US)

(72) Inventors: Jeke Kumar Gochhayat, Bangalore (IN); Arun Surendhran Nair, Bangalore (IN); Chandrasekhar Puthillathe, Bangalore (IN)

(21) Appl. No.: 19/257,849

(22) Filed: Jul. 2, 2025

(30) Foreign Application Priority Data
Mar. 19, 2025 (IN) 202511024873

(51) Int. Cl. G06F 13/38; G06F 13/42

(52) U.S. Cl. CPC G06F 13/382; G06F 13/4282; G06F 2213/0042

(57) ABSTRACT

In some examples, an electronic device includes a port to connect to an external device. The electronic device includes a management controller having an interface controller to manage communications over a connection through the port. The management controller can receive an indication of a connection of the external device to the port, and obtain, from the external device, type information indicating a type of the external device. The management controller can selectively set a role of the electronic device by controlling a role setting of the interface controller, the role selected from a host role or a device role on the connection between the electronic device and the external device. The management controller can interact with the external device based on the set role.

### BACKGROUND

An electronic device includes ports to connect to external devices. An external device can connect to a port of the electronic device using a cable. Once connected, the electronic device and the external device can interact with one another through the connection.

### BRIEF DESCRIPTION OF THE DRAWINGS

Some implementations of the present disclosure are described with respect to the following figures.

FIG. 1 is a block diagram of an arrangement including a server and external devices that can connect to the server, according to some examples.

FIG. 2 is a flow diagram of a process involving a server and an external device connected to a service port of the server, according to some examples.

FIG. 3 is a block diagram of an electronic device according to some examples.

FIG. 4 is a block diagram of a storage medium storing machine-readable instructions according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Some electronic devices include management controllers to perform management tasks with respect to the electronic devices. An example of a management controller is a baseboard management controller (BMC). The management controller of an electronic device may be connected to a service port of the electronic device. An external device may connect to the service port. In some cases, it may be desirable to use an external device to perform management of the electronic device via a connection between the external device and the management controller through the service port of the electronic device. If the electronic device is a server, then performing management of the server by connecting the external device (e.g., a notebook computer, a tablet computer, or another handheld device) to the service port is referred to as "at-the-server management." At-the-server management of the server refers to management of the server performed by support personnel after physically connecting the external device to the service port of the server. More generally, an external device can be physically connected to the service port of an electronic device to perform "at-the-device management" of the electronic device.

In some examples, the service port of an electronic device includes a Universal Serial Bus (USB) service port. In such examples, a USB-Ethernet dongle may have to be used to connect an Ethernet port of an external device to the USB service port of the electronic device that is to be managed. A "dongle" refers to an adapter that provides added functionality not available at the electronic device. For example, the USB-Ethernet dongle converts between USB signals and Ethernet signals. Having to use a dongle to connect the external device to the service port of an electronic device to perform management of the electronic device increases complexity, reduces flexibility, and increases costs. Service personnel would have to purchase or otherwise acquire a dongle to allow the service personnel to perform at-the-device management of the electronic device. Further, in some cases, external devices used to perform management of electronic devices may not include Ethernet ports, so that a USB-Ethernet dongle would be useless in such cases.

A further challenge associated with at-the-device management of electronic devices involves switching roles of the management controller of the electronic device based on the type of an external device connected to the service port. Different types of external devices connected to the service port of the electronic device may have different roles, including a host role and a device role. If the service port is a USB service port, the host role is a USB host role, and the device role is a USB device role. If the external device connected to the service port of the electronic device has the device role, then the management controller should be set to operate according to the host role. On the other hand, if the external device connected to the service port of electronic device has the host role, then the management controller should operate according to the device role. Although the USB 2.0 On-the-Go (OTG) protocol defines a procedure by which USB devices connected to one another can switch between host and device roles, the OTG protocol is useable with USB 2.0 ports but not other types of USB ports, such as the USB Type C (USB-C) port. As a result, if the service port of an electronic device is a USB-C port or any other service port that does not support USB 2.0 OTG, then at-the-device management of the electronic device through the service port may not be possible.

In accordance with some examples of the present disclosure, a management controller of an electronic device with a service port includes an interface controller to manage communications over a connection through the service port, where the management controller can receive an indication of a connection of the external device to the service port, obtain, from the external device, type information indicating a type of the external device, and selectively set a role of the electronic device by controlling a role setting of the interface controller. The role is selected from a host role or a device role on the connection between the electronic device and the port. The management controller can interact with the external device based on the role set for the electronic device.

In examples where the service port is a USB-C service port, an external device with a USB-C port can directly connect to the USB-C service port to perform at-the-device management of an electronic device. The direct connection can be over a cable. Alternatively, the direct connection can be accomplished by plugging in the external device to the USB-C service port.

As a result of the ability to directly connect the external device to the service port of the electronic device, use of dongles such as USB-Ethernet dongles can be avoided, thereby increasing convenience and flexibility and reducing costs. The ability of the management controller to change the role setting of the interface controller to switch between host and device roles allows the service port of the electronic device to connect to different types external devices, including an external device having the host role (e.g., for performing at-the-device management of the electronic device) or an external device having the device role (to allow for the management controller to act as a host when interacting with the external device having the device role).

A "service port" refers to a port of an electronic device that is used to perform out-of-band tasks with respect to the electronic device, including management of the electronic device or outputting service information (e.g., logs) to an external device. The service port is separate from another port of the electronic device through which the electronic device performs communications with other devices as part of normal operations of the electronic device, including operations of application programs, an operating system (OS), system firmware, etc.

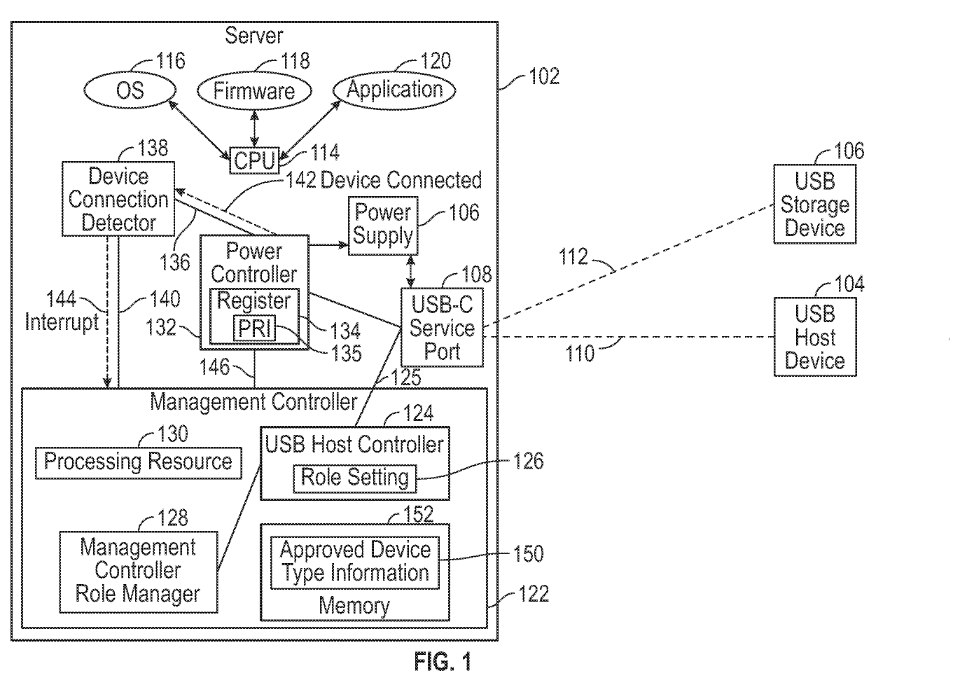

FIG. 1 is a block diagram of an example arrangement including a server 102 that can connect to any of various different external devices, including a USB host device 104 and a USB storage device 106. Although reference is made to a server as an example of an electronic device, in other examples, other types of electronic devices can include a similar arrangement of components as shown for the server 102 in FIG. 1.

The server 102 includes a USB-C service port 108 to which the USB host device 104 or the USB storage device 106 can connect over respective cables 110 and 112. In other examples, instead of using cables, the USB host device 104 or the USB storage device 106 can directly plug into the service port 108. Each of the USB host device 104 and the USB storage device 106 has a USB-C port to connect to the server's service port 108.

Although reference is made to a USB-C service port and USB external devices in FIG. 1, in other examples, other types of service ports that operate according to other communication protocols can be employed to connect to other types of external devices. Other types of communication protocols can include the Thunderbolt communication protocol, the Lightning communication protocol, or another communication protocol.

The USB storage device 106 is an example of an external device that operates according to a USB device role. In other examples, other types of USB devices (different from the USB storage device 106) that can operate according to the USB device role can be connected to the server's service port 108. As discussed further below, certain types of USB devices that operate according to the USB device role are not allowed to be connected to the server's service port 108.

The USB host device 104 operates according to a USB host role. Examples of the USB host device 104 may include any or some combination of the following: a notebook computer, a handheld device such as a tablet computer or a smartphone, or another type of device that can act as a host relative to the server 102.

A USB device that has the USB host role is able to initiate and manage communications over a USB bus, control power to devices connected to the USB bus, arbitrate access of the USB bus among multiple USB devices, and perform other tasks. A USB device that has the USB device role responds to communications from a USB host.

The server 102 includes a central processing unit (CPU) 114, which can include one or more hardware processors. The CPU 114 executes primary machine-readable instructions of the server 102, including an OS 116, system firmware 118, and an application program 120. The system firmware 118 can include boot code, such as Basic Input/Output System (BIOS) code or Universal Extensible Firmware Interface (UEFI) code.

The server 102 also includes a management controller 122 that is separate from the CPU 114. An example of the management controller 122 is a BMC. More generally, the management controller 122 can refer to another type of controller that can perform management tasks with respect to the server 102 (or any other type of electronic device). The management controller 122 may be implemented using a single integrated circuit (IC) device or a collection of IC devices (which can be mounted on a circuit board, for example).

Machine-readable instructions executed by a processing resource 130 of the management controller 122 are separate from the primary machine-readable instructions executed by the CPU 114. The processing resource 130 of the management controller 122 is separate from the CPU 114.

The management controller 122 includes a USB host controller 124 that supports communications over a USB bus 125 and through the service port 108. The USB host controller 124 is capable of switching between a USB host role and a USB device role. For example, the USB host controller 124 may be an Extensible Host Controller Interface (xHCI) controller according to the xHCI Specification. The xHCI Specification provides a framework relating to how a host controller operates with respect to a USB port. In other examples, other types of USB host controllers that can switch between USB host and device roles can be employed.

The USB host controller 124 when set to the USB host role is able to initiate and manage communications over the USB bus, control power to the USB bus, arbitrate access to the USB bus among multiple USB devices, and perform other tasks. The USB host controller 124 when set to the USB device role responds to communications from a USB host, such as the USB host device 104 when connected to the service port 108.

The USB host controller 124 stores a role setting 126 to indicate the USB role of the USB host controller. The role setting 126 when set to a first value ("host value") indicates that USB host controller 124 has the USB host role, and the role setting 126 when set to a different second value ("device value") indicates that the USB host controller 124 has the USB device role. The role setting 126 can include one or more bits stored in a configuration register (or another storage element) of the USB host controller 124, for example. The role setting 126 is switchable between the host value and the device value.

In other examples where the service port 108 is not a USB port but a port according to another technology, an interface controller can be used to manage communications through the service port 108. Examples of other ports according to other technologies can include a Thunderbolt port, the Lightning port, or another type of port.

The management controller 122 also includes a management controller role manager 128 that selectively sets the role setting 126 to the host value or the device value based on information associated with an external device (e.g., the USB host device 104 or the USB storage device 106) connected to you the service port 108. The management controller role manager 128 can be implemented as machine-readable instructions executed by the processing resource 130 of the management controller 122.

In some examples, the server 102 also includes a power controller 132, such as a power controller that operates according to the USB Power Delivery (USB-PD) Protocol. When operating according to the USB-PD protocol, the power controller 132 is referred to as a USB-PD controller. More generally, the power controller 132 can refer to any type of controller that can control the delivery or receipt of power through a port of the server 102.

The power controller 132 can detect the connection of an external device to the service port 108 and to detect a direction of power flow over a USB connection, which depends on the power role of the external device. The power role of the external device can be either a power role (in which the external device is a source of power for the server 102) or a power sink role (in which the external device receives power delivered by the server 102). Based on the power role of the external device, the power controller 132 can determine the corresponding power role of the server 102 relative to the external device. The server's power role can either be a power source role or a power sink role.

The server 102 includes a power supply 160 that supplies power voltages to power electronic components of the server 102. The power source of the power supply 160 may include a battery, a wall outlet adapter, or any other type of power source. When the power controller 132 determines that the power role of the server 102 is the power source role, the power controller 132 controls the power path of the server 102 to allow the power supply 160 to deliver power through the service port 108 to the external device, such as the USB storage device 106. When the power controller 132 determines that the power role of the server 102 is the power sink role, the power controller 132 controls the power path of the server 102 to allow power to be received through the service port 108 from the external device, such as the USB host device 104.

The power controller 132 includes a register 134 (or another type of storage element) that stores a power role indicator (PRI) 135 for the external device connected to the service port 108. The PRI 135 can include a bit or a collection of bits in the register 134, for example. The PRI 135 when set to a first value ("power source value") indicates that the server 102 has a power source role through the service port 108. In contrast, the PRI 135 when set to a different second value ("power sink value") indicates that the server 102 has a power sink role through the service port 108. In alternative examples, the PRI 135 can be set to different values to indicate whether the external device has the power source role or the power sink role.

The power controller 132 is connected over a link 136 to a device connection detector 138. In some examples, the device connection detector 138 can be implemented using a programmable logic device, such as a complex programmable logic device (CPLD), an application-specific integrated circuit (ASIC) device, a programmable gate array (PGA), or another type of programmable logic device. The device connection detector 138 is connected over a link 140 to the management controller 122. When the power controller 132 detects a connection of an external device to the service port 108, the power controller 132 sends a device connected signal 142 to the device connection detector 138. in some examples, the power controller 132 can include general purpose input/output (GPIO) pins. One of the GPIO pins can provide the device connected signal 142 to the device connection detector 138. In other examples, another pin of the power controller 132 can be used to provide the device connected signal 142.

In response to the device connected signal 142 being asserted to indicate that an external device is connected to the service port 108, the device connection detector 138 sends an interrupt signal 144 to the management controller 122 over the link 140. The management controller 122 can have an interrupt signal input pin to receive the interrupt signal 144. In another example, another type of signal can be sent from the device connection detector 138 to another input pin of the management controller 122.

Although FIG. 1 shows an example that includes the management controller 122, the power controller 132, and the device connection detector 138 as separate and discrete components, it is noted that one or more of the management controller 122, the power controller 132, and the device connection detector 138 can be integrated into fewer electronic components. For example, the functionality of the power controller 132 and/or the device connection detector 138 may be incorporated into the management controller 122. As another example, the power controller 132 can send an indication directly to the management controller 122 indicating that the external device has been connected to the service port 108. In the latter example, the device connection detector 138 may be omitted.

The management controller 122 is connected to the power controller 132 over a bus 146, such as an I2C bus, an I3C bus, a Serial Peripheral Interface (SPI) bus, or another type of bus. The management controller 122 is able to access the power controller 132 over the bus 146, including accessing the register 134 to obtain the value of the PRI 135 for determining the power role of the server 102 through the service port 108.

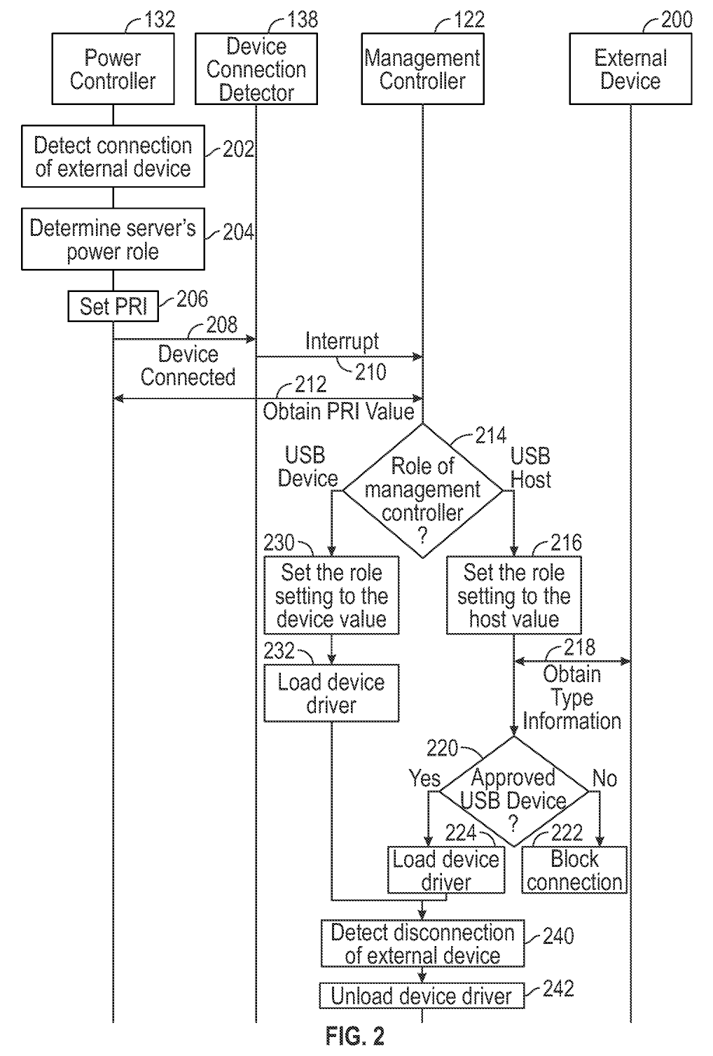

The following refers to both FIG. 1 and FIG. 2. FIG. 2 is a flow diagram a process that involves the management controller 122, the device connection detector 138, the power controller 132, and an external device 200. The external device 200 may be the USB host device 104 that has the USB host role, or a USB device that has the USB device role. An example of a USB device having the USB device roles is the USB storage device 106.

The power controller 132 detects (at 202) a connection of the external device 200 to the server's service port 108. The power controller 132 additionally determines (at 204) a power role of the server 102 relative to the external device 200. For example, the power controller 132 can perform a negotiation (such as according to the USB-PD protocol) with the external device 200 to negotiate the direction of power flow through the USB connection including the service port 108 and other properties (e.g., the power voltage and current).

The power controller 132 can selectively set (at 206) the PRI 135 based on the negotiated direction of power flow. The power controller 132 can set the PRI 135 to the power source value to indicate that the server 102 has a power source role through the service port 108 if the power negotiation determines that the external device 200 is a power sink (e.g., the USB storage device 106 or another USB device). In contrast, the power controller 132 can set the PRI 135 to the power sink value to indicate that the server 102 has a power sink role through the service port 108 if the power negotiation determines that the external device 200 is a power source (e.g., the USB host device 104). If the PRI 135 is a single bit, then the power source value can be "1" and the power sink value can be "0," or vice versa. If the PRI 135 includes multiple bits, the power source value and the power sink value can be other values.

In response to detecting the connection of the external device 200 to the service port 108, the power controller 132 sends (at 208) the device connected signal 142 to the device connection detector 138. In response, the device connection detector 138 sends (at 210) the interrupt signal 144 to the management controller 122.

In response to the interrupt signal 144, the management controller 122 accesses the register 134 in the power controller 132 to obtain (at 212) the value of the PRI 135. For example, the management controller 122 can issue a register read request to the power controller 132 to read the content of the register 134, which includes the PRI 135.

The management controller role manager 128 determines (at 214) a USB role of the management controller 122 based on the value of the PRI 135. If the PRI 135 has a power source value, then the management controller role manager 128 determines (at 214) that the management controller 122 is to operate as a USB host relative to the external device 200, and the management controller role manager 128 sets (at 216) the role setting 126 to the host value to indicate that the USB host controller 124 has the USB host role. Note that in this case the external device 200 has the USB device role.

In some examples, if the USB host controller 124 is set to the USB host role as a default, the management controller role manager 128 can simply maintain the role setting 126 at the host value in response to determining that the management controller 122 is to operate as a USB host.

The management controller role manager 128 obtains (at 218) type information indicating a type of the external device 200 (which has the USB device role). In some examples, the type information includes a USB class code that is stored at the external device 200. The USB class code can be part of a device descriptor of a USB device. The device descriptor can include any or some combination of the following information of the external device 200: a USB class code, a supported USB version, a maximum packet size, vendor and product identifiers, device configurations, and so forth.

The management controller role manager 128 can issue a read request over the USB connection (through the service port 108) to the external device 200 to obtain the device descriptor. The external device 200 provides the device descriptor to the management controller 122 in response to the read request.

The management controller role manager 128 can compare the type information (e.g., USB class code obtained from the device descriptor) to a list of approved device types. The list of approved device types indicates which types of USB devices are approved to be connected to the service port 108. The list of approved device types can be part of approved device type information 150 stored in a memory 152 of the management controller 122 (FIG. 1). In some examples, the list of approved types can include a list of approved USB class codes.

In other examples, instead of using a list of approved device types, the type information obtained from the external device 200 can be compared to a list of prohibited device types. The list of prohibited device types identifies device types that are not allowed to be connected to the service port 108.

A "list" can refer to any data structure that contains specific information. The list may be in text form, in the form of a tree, or in any other form.

An example approved device type of a USB device (having the USB device role) that is allowed to be connected to the service port 108 is a storage device type. The USB storage device 106 is an example of a USB device of the storage device type. Other types of allowed device types can include a display device type (e.g., a display device to display information), an audio device type (e.g., an audio device to input or output audio information), and so forth.

An example device type of USB device (having the USB device role) that is not allowed is a wireless router type. A WI-FI router is an example USB device of the wireless router type. A USB device of the wireless router type is not allowed to connect to the service port 108 to prevent a wireless router from being used to perform an unauthorized access to the management controller 122 by an unauthorized entity. Another device type that is not allowed is a network interface controller type (e.g., a network interface card to connect to a network).

The management controller role manager 128 determines (at 220) whether the external device 200 (having the USB device role) is an approved USB device, such as by comparing the obtained type information to the list of approved device types (or alternatively, to a list of prohibited device types). If the external device 200 is not an approved USB device, the management controller role manager 128 blocks (at 222) the connection of the external device to the server 102. Blocking the connection can involve configuring the USB host controller 124 to prevent communications with the external device 200.

However, if the external device 200 (having the USB device role) is an approved USB device, the management controller 122 loads (at 224) a device driver for the external device 200 for execution by the processing resource 130 of the management controller 122. The loaded device driver manages interactions with the external device 200. For example, if the external device 200 is the USB storage device 106, the management controller 122 can mount the USB storage device 106 as a storage volume, and the management controller 122 can download data (e.g., logs or other types of data) to store in the storage volume in response to management commands. The management controller 122 can also perform other management tasks with respect to the USB storage device 106.

If the PRI 135 has a power sink value, then the management controller role manager 128 determines (at 214) that the management controller 122 is to operate as a USB device relative to the external device 200, and the management controller role manager 128 sets (at 230) the role setting 126 to the device value to indicate that the USB host controller 124 has the USB device role. Note that in this case the external device 200 has the USB host role. An example of such an external device 200 is the USB host device 104.

If the role setting 126 is switched from the host value to the device value (at 230), the management controller role manager 128 can reset the USB host controller 124 so that the USB host controller 124 can restart in the USB device role on the USB connection.

The management controller 122 loads (at 232) a device driver for the USB host device 104 for execution by the processing resource 130 of the management controller 122. For example, the device driver loaded can include a USB network driver to support network communications according to a protocol, such as the Network Control Protocol, the Transmission Control Protocol (TCP), the User Datagram Protocol (UDP), or another communication protocol.

The loaded USB network driver allows the management controller 122 to appear as a network device to the connected USB host device 104. The management controller 122 can also configure (at 234) network addresses, such as Internet Protocol (IP) addresses, for the management controller 122 and for the USB host device 104. The IP addresses configured for the management controller 122 and the USB host device 104 allows the management controller 122 and the USB host device 104 to perform network communications with one another through the USB connection. In some examples, the IP addresses are non-routable, link-local IP addresses. A link-local IP address is an IP address that is valid only for communication within a local network segment or the link that a device is connected to (e.g., the USB connection between the management controller 122 and the USB host device 104). The link-local IP addresses are not routable, meaning they cannot be used to communicate with devices outside the local network segment.

In some examples, the USB host device 104 can access one or more management interfaces of the management controller 122. Examples of such management interfaces can include any or some combination of the following: a graphical user interface (GUI) of the management controller 122, an integrated remote console (IRC) of the management controller 122, a Redfish interface of the management controller 122, or another type of interface of the management controller 122. The USB host device 104 can use the management interface of the management controller 122 to perform at-the-server management of the server 102.

Examples of at-the-server management tasks that can be performed by the USB host device 104 with respect to the server 102 include any or some combination of the following: performing diagnostics or tests to identify or repair an issue in the server 102, upgrade machine-readable instructions (software or firmware) of the server 102, updating a configuration of the server 102, or perform other management tasks with respect to the server 102.

In some cases, the machine-readable instructions that are upgraded can include machine-readable instructions of the management controller 122. For example, an existing management controller may be removed and replaced with a new management controller. For the new management controller to operate, the USB host device 104 can connect to the service port 108 to install machine-readable instructions in the new management controller, or in a nonvolatile memory to which the new management controller is connected.

At a later point in time, the external device 200 can be disconnected from the service port 108. The USB host controller 124 in the management controller 122 can detect (at 240) the disconnection of the external device 200. In response to detecting the disconnection of the external device 200, the management controller 122 unloads (at 242) any device driver for the external device 200 that was previously loaded.

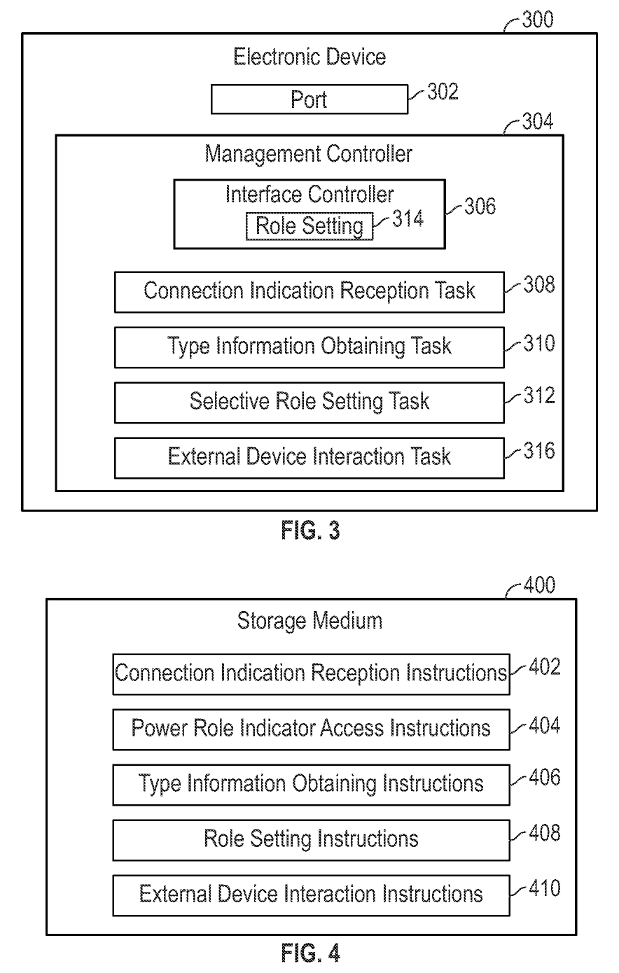

FIG. 3 is a block diagram of an electronic device 300 according to some examples of the present disclosure. An example of the electronic device 300 is the server 102 of FIG. 1.

The electronic device 300 includes a port 302 to connect to an external device. An example of the port 302 is the USB-C service port 108 of FIG. 1.

The electronic device 300 includes a management controller 304 that has an interface controller 306 to manage communications over a connection through the port 302. An example of the interface controller 306 is the USB host controller 124 of FIG. 1. An example of the management controller 304 is a BMC.

The management controller 304 can perform various tasks, such as when machine-readable instructions are executed by the management controller 304. The management controller tasks include a connection indication reception task 308 to receive an indication of a connection of the external device to the port 302. The indication may be the interrupt signal 144 from the device connection detector 138 of FIG. 1. Alternatively, the indication may be another signal from the device connection detector 138 or from another component (e.g., the power controller 132) of the electronic device 300.

The management controller tasks include a type information obtaining task 310 to obtain, from the external device, type information indicating a type of the external device. For example, if the external device is a USB device, the type information can include a USB class code in a device descriptor at the USB device.

The management controller tasks include a selective role setting task 312 to selectively set a role of the electronic device 300 by controlling a role setting 314 of the interface controller 306. The role selected is either a host role or a device role on the connection between the electronic device 300 and the external device.

The management controller tasks include an external device interaction task 316 to interact with the external device based on the set role. The interaction can include the management controller 304 acting as a host or a device with respect to the external device.

In some examples, the electronic device 300 further includes a power controller connected to the port 302. The management controller 304 can access a power role indicator in the power controller, where the power role indicator indicates whether the electronic device is a power source or a power sink relative to the external device. An example of the power role indicator is the PRI 135 of FIG. 1. The power role indicator may indicate whether the electronic device 300 has the power source role or the power sink role. Alternatively, the power role indicator may indicate whether the external device has the power source role or the power sink role. In a specific example, the power controller may be a USB-PD controller.

In some examples, the management controller 304 can control a value of the role setting 314 of the interface controller 306 based on the power role indicator.

In some examples, the management controller 304 can select a device driver to load based on the type information. For example, the management controller 304 can load a first device driver to interact with the external device having the device role. In these examples, the management controller 304 executes the first device driver and operates according to the host role when interacting with the external device.

In further examples, the management controller 304 can load a second device driver to interact with the external device having the host role. In such further examples, the management controller 304 executes the second device driver and operates according to the device role when interacting with the external device.

In some examples, the management controller 304 can selectively set the role of the electronic device to the device role, and the management controller 304 can load a network device driver to cause the management controller 304 to appear as a network device to the external device.

In some examples, the management controller can assign network addresses to the management controller and the external device to allow network communications between the management controller and the external device using the network addresses.

In some examples, the network addresses assigned are non-routable, link-local IP addresses.

In some examples, management controller 304 includes a management interface (e.g., a GUI, an IRC, a Redfish interface, etc.) accessible to the external device to perform at-the-device management of the electronic device 300.

In some examples, the management controller 304 can access role information in a register (e.g., the register 134 of the power controller 132 in FIG. 1) to determine whether the management controller 304 has the host role or the device role. Responsive to determining that the management controller 304 has the host role and the external device has the device role, the management controller 304 can compare the type information indicating the type of the external device to a list of device types. The management controller 304 can accept or block the connection of the external device based on the comparison. The list of device types can include a list of approved device types or a list of prohibited device types.

In some examples, if the list of device types is a list of approved device types, the management controller 304 can accept the connection of the external device based on the type of the external device being in the list of approved device types.

FIG. 4 is a block diagram of a non-transitory machine-readable or computer-readable storage medium 400 storing machine-readable instructions that upon execution cause a management controller of an electronic device to perform various tasks.

The machine-readable instructions include connection indication reception instructions 402 to receive an indication of a connection of an external device to a service port of the electronic device. The service port may be a USB-C service port, for example.

The machine-readable instructions include power role indicator access instructions 404 to access a power role indicator to determine a power role of the electronic device relative to the external device. The power role may be a power source role or a power sink role.

The machine-readable instructions include type information obtaining instructions 406 to obtain, from the external device, type information indicating a type of the external device. The type information can include a USB class code, for example.

The machine-readable instructions include role setting instructions 408 to selectively set, based on the power role indicator, a role of the electronic device by controlling a role setting of an interface controller for the service port. The role is selected from a host role or a device role on the connection between the electronic device and the external device.

The machine-readable instructions include external device interaction instructions 410 to interact with the external device having the type indicated by the type information based on the set role.

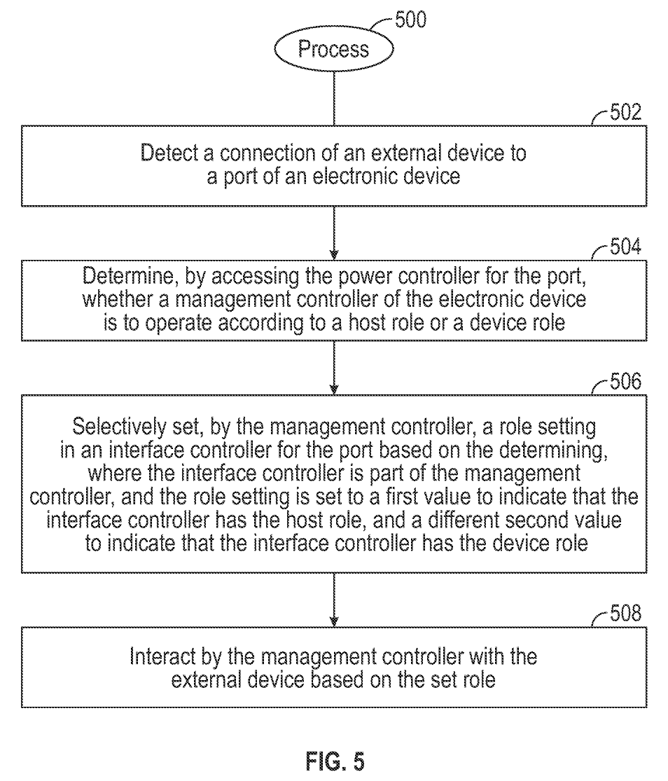

FIG. 5 is a flow diagram of a process 500 according to some examples of the present disclosure. The process 500 may be performed by an electronic device including a management controller, such as the management controller 122 of FIG. 1.

The process 500 includes detecting (at 502) a connection of an external device to a port of an electronic device. The detection can be performed by a power controller (e.g., 132 in FIG. 1).

The process 500 includes determining (at 504), by accessing the power controller for the port, whether a management controller of the electronic device is to operate according to a host role or a device role. For example, the management controller can access the PRI 135 stored in the power controller 132 of FIG. 1.

The process 500 includes selectively setting (at 506), by the management controller, a role setting in an interface controller for the port based on the determining, where the interface controller is part of the management controller, and the role setting is settable to a first value to indicate that the interface controller has the host role, and a different second value to indicate that the interface controller has the device role.

The process 500 includes interacting (at 508) by the management controller with the external device based on the set role. The management controller can operate according to a host role or a device role.

As used here, a "processing resource" can include one or more hardware processors. A hardware processor can include a microprocessor, a core of a multi-core microprocessor, a microcontroller, a programmable integrated circuit, a programmable gate array, or another hardware processing circuit.

A "register" can refer to any device capable of storing information.

An "electronic device" or "device" can refer to any or some combination of the following: a desktop computer, a notebook computer, a vehicle, a communication node, a storage system, or any other type of electronic device.

FIGS. 2 and 5 are flow diagrams of processes including tasks performed in depicted orders. In other examples, the tasks of any of the processes may be performed in a different order, some of the tasks may be omitted, and other tasks may be added.

A "BMC" can refer to a specialized service controller that monitors the physical state of an electronic device using sensors and communicates with a remote management system (that is remote from the electronic device) through an independent "out-of-band" connection. The BMC can perform management tasks to manage components of the electronic device. Examples of management tasks that can be performed by the BMC can include any or some combination of the following: power control to perform power management of the electronic device (such as to transition the electronic device between different power consumption states in response to detected events), thermal monitoring and control of the electronic device (such as to monitor temperatures of the electronic device and to control thermal management states of the electronic device), fan control of fans in the electronic device, system health monitoring based on monitoring measurement data from various sensors of the electronic device, remote access of the electronic device (to access the electronic device over a network, for example), remote reboot of the electronic device (to trigger the electronic device to reboot using a remote command), system setup and deployment of the electronic device, system security to implement security procedures in the electronic device, and so forth.

In some examples, the BMC can provide so-called "lights-out" functionality for the electronic device. The lights out functionality may allow a user, such as a systems administrator, to perform management operations on the electronic device even if an OS is not installed or not functional on the electronic device.

Moreover, in some examples, the BMC can run on auxiliary power provided by an auxiliary power source; as a result, the electronic device does not have to be powered on to allow the BMC to perform the BMC's operations. The auxiliary power source is separate from a primary power supply that supplies powers to other components (e.g., a main processor, a memory, an I/O device, etc.) of the electronic device.

A storage medium (e.g., 400 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An electronic device comprising:
a port to connect to an external device; and
a management controller comprising an interface controller to manage communications over a connection through the port, the management controller to:
receive an indication of a connection of the external device to the port;
obtain, from the external device, type information indicating a type of the external device;
selectively set a role of the electronic device by controlling a role setting of the interface controller, the role selected from a host role or a device role on the connection between the electronic device and the external device; and
interact with the external device based on the set role.

2. The electronic device of claim 1, further comprising:
a power controller connected to the port,
wherein the management controller is to access a power role indicator in the power controller, the power role indicator indicating whether the electronic device is a power source or a power sink relative to the external device.

3. The electronic device of claim 2, wherein the management controller is to control a value of the role setting of the interface controller based on the power role indicator.

4. The electronic device of claim 3, wherein the power controller comprises a Universal Serial Bus (USB) power delivery (USB-PD) controller.

5. The electronic device of claim 1, wherein the management controller is to select a device driver to load based on the type information.

6. The electronic device of claim 5, wherein the management controller is to:
load a first device driver to interact with the external device having the device role,
wherein the management controller is to execute the first device driver and operate according to the host role when interacting with the external device.

7. The electronic device of claim 6, wherein the management controller is to:
load a second device driver to interact with the external device having the host role,
wherein the management controller is to execute the second device driver and operate according to the device role when interacting with the external device.

8. The electronic device of claim 1, wherein the management controller is to: selectively set the role of the electronic device to the device role; and
load a network device driver to cause the management controller to appear as a network device to the external device.

9. The electronic device of claim 8, wherein the management controller is to assign network addresses to the management controller and the external device to allow network communications between the management controller and the external device using the network addresses.

10. The electronic device of claim 9, wherein the network addresses assigned are non-routable, link-local Internet Protocol (IP) addresses.

11. The electronic device of claim 8, wherein the management controller comprises a management interface accessible to the external device to manage the electronic device.

12. The electronic device of claim 1, wherein the management controller is to:
access role information in a register to determine whether the management controller has the host role or the device role;
responsive to determining that the management controller has the host role and the external device has the device role, compare the type information indicating the type of the external device to a list of device types; and
accept or block the connection of the external device based on the comparison.

13. The electronic device of claim 12, wherein the list of device types comprises a list of approved device types, and wherein the management controller is to:
accept the connection of the external device based on the type of the external device being in the list of approved device types, wherein an approved device type in the list of approved device types includes a storage device type.

14. The electronic device of claim 1, wherein the port comprises a Universal Serial Bus Type C (USB-C) port.

15. The electronic device of claim 14, wherein the type information comprises a class code of a Universal Serial Bus (USB) device descriptor at the external device.

16. A non-transitory machine-readable storage medium comprising instructions that upon execution cause a management controller of an electronic device to:
receive an indication of a connection of an external device to a service port of the electronic device;
access a power role indicator to determine a power role of the electronic device relative to the external device;
obtain, from the external device, type information indicating a type of the external device;
selectively set, based on the power role indicator, a role of the electronic device by controlling a role setting of an interface controller for the service port, the role selected from a host role or a device role on the connection between the electronic device and the external device; and
interact with the external device having the type indicated by the type information based on the set role.

17. The non-transitory machine-readable storage medium of claim 16, wherein the instructions upon execution cause the management controller to:
based on determining from the power role indicator that the external device has the device role, determine whether the type of the external device indicated by the type information is approved for connection to the service port; and
responsive to determining that the type of the external device indicated by the type information is approved for connection to the service port, load a device driver for the external device to allow the management controller to interact with the external device.

18. The non-transitory machine-readable storage medium of claim 17, wherein the instructions upon execution cause the management controller to:
responsive to determining that the type of the external device indicated by the type information is not approved for connection to the service port, block the connection of the external device to the service port.

19. A method comprising:
detecting a connection of an external device to a port of an electronic device;
determining, by accessing a power controller for the port, whether a management controller of the electronic device is to operate according to a host role or a device role;
selectively setting, by the management controller, a role setting in an interface controller for the port based on the determining, wherein the interface controller is part of the management controller, the role setting settable to a first value to indicate that the interface controller has the host role, and a different second value to indicate that the interface controller has the device role; and
interacting by the management controller with the external device based on the set role.

20. The method of claim 19, comprising:
based on the role setting being set to the second value, load a network device driver to allow the external device to access a management interface of the management controller to perform at-the-device management of the electronic device.
